(19) United States
(12) Patent Application Publication
(10) Pub. No.: US 2023/0128212 A1
(43) Pub. Date: Apr. 27, 2023

(54) VEHICLE RUNNING-CONTROL PROCESSING SYSTEM

(71) Applicant: Mitsubishi Electric Corporation, Tokyo (JP)

(72) Inventors: Michitoshi AZUMA, Tokyo (JP); Toru Higuchi, Tokyo (JP); Takatoshi Kakuta, Tokyo (JP); Toshihide Satake, Tokyo (JP); Fumiaki Kadoya, Tokyo (JP); Takahisa Aoyagi, Tokyo (JP)

(73) Assignee: Mitsubishi Electric Corporation, Tokyo (JP)

(21) Appl. No.: 17/897,811

(22) Filed: Aug. 29, 2022

(30) Foreign Application Priority Data
Oct. 27, 2021 (JP) 2021-175137

(51) Int. Cl. B60W 30/095; G08G 1/16; G08G 1/01; B60W 60/00; B60W 10/20; B60W 30/02; B60W 10/18; B60W 30/09

(52) U.S. Cl. CPC B60W 30/0956; G08G 1/16; G08G 1/0145; B60W 60/0015; B60W 30/0953; B60W 10/20; B60W 30/02; B60W 10/18; B60W 30/09; B60W 2556/45; B60W 2520/26; B60W 2555/20; B60W 2552/00

(57) ABSTRACT

An apparatus is obtained which provides, to a vehicle, information on a road-surface and that on an obstacle(s), and information on the degree of reliability, on the basis of information received from roadside units. The apparatus includes a communications circuitry to receive obstacle information from the roadside units where each unit includes a plurality of sensors to detect the obstacle(s) within a predetermined field of view. A reliability determinator determines the degree of reliability of information on an obstacle(s) received, and outputs a reliability value on the bases of the number of roadside units detecting the same obstacle, the number of sensors in one roadside unit detecting the same obstacle, and a difference value of detecting the same obstacle between different roadside units or that of detecting the same obstacle between different sensors; and a correction term is outputted on the basis of information on a road-surface condition.

### TECHNICAL FIELD

The disclosure of the present application relates to a vehicle running-control processing system.

### BACKGROUND ART

In recent years, the introduction of an information and telecommunications technology such as so-called “big data” and/or a 5th generation mobile communication system technology, 5G, has been underway in mobility-technology fields in addition to utilizing artificial intelligence (Artificial Intelligence, AI) commonly referred to as “deep learning,” so that active developments have been underway for automation on transportation of people (human beings) or things (goods). According to the introduction of these high technologies, it is expected to solve various outstanding social problems such as a resolution to clear up a so-called “last one mile” problem, improvement of driver shortages in the field of physical distribution, and/or improvement of traffic congestion, which have been conventionally difficult to be solved.

For example, in vehicles which are operating within a specific area in such area as a factory, a driver conventionally uses a truck or a towed carriage, so that goods are transported thereby from a certain point of location to a specific point of location. However, in order to enhance an operation efficiency rate in a factory, it is necessary to operate the transportation within the factory at all times. Meanwhile, according to a method to solve such a problem by increasing the number of vehicles capable of being towed, or that by increasing transportation time periods, it is necessary to increase facility costs and/or human labor costs of drivers, which heavily burdens business owners. Because of such a social background, it is desired to promote automated driving of transportation-purpose vehicles.

By the way, technical levels of the automated driving in general-purpose vehicles are defined for their classifications by the Society of Automotive Engineers (SAE), and their determinant indicators are adopted by many manufacturers and/or social organizations. Although detailed explanation will be omitted here, the obligation is required for a human driver to monitor a vehicle at up to automated driving levels 0 through 3; whereas, at the automated driving level 4 and above, automated running of the vehicle can be continued without having the obligation for a human driver to monitor the vehicle at all times.

And then, in order to achieve an automated driving system at the automated driving level 4 or more, it is required in many vehicles to mount thereon front cameras for monitoring an obstacle situated toward the front of a vehicle, millimeter-wave radar sensors (MMWR sensors) for monitoring an obstacle situated toward the front of a vehicle or toward the rear thereof by utilizing a frequency band of 24 to 79 GHz, optics or optical sensors (Light Detection and Ranging sensors, or LiDAR sensors) each for measuring a distance to an obstacle in the surroundings of a vehicle based on point-cloud information obtainable by means of reflection of a laser, ultrasonic sensors each for measuring the distance between an obstacle and a vehicle by means of the reflections of ultrasonic waves, and/or the like.

In automated driving, there is an automated driving assistance system for assisting the automated driving of a motor vehicle, as a device for the automated driving whose attention is paid to an obstacle described above, in which scheduled running road-routes and information on the obstacle thereamong are utilized (for example, refer to Japanese Patent Laid-Open No. 2017-117079).

In addition, in a motor vehicle including its sensors, an automated driving assistance system is known on which, together with a running control device, a route producing device whose calculation load for producing a running route is lessened is mounted on the motor vehicle (for example, refer to Japanese Patent Laid-Open No. 2021-62653). However, even if a group of sensors described above is mounted on a vehicle, there exists a blind spot originated as a cause in a limit of a field of view (Field of View, FoV) by a sensor(s) in such a group of sensors; and in addition, when it is presumed that the aforementioned group of sensors is mounted on the vehicle, its sensor costs increase. Moreover, there also arises a problem that is caused in which, when automated driving vehicles are running more in number, an automated driving vehicle cannot determine whether the running of what vehicle should better be put on at higher priority without having supportive determination of a priority order for the automated running.

### Problems to be Solved by the Invention

In order to solve such problems as described above, developments have been underway for an automated driving system in which automated driving vehicles are arbitrated between themselves by making use of roadside units (hereinafter, also referred to as “RSUs”; Road Side Units, RSUs), a multi-access edge computer(s) (Multi-access Edge Computer, “MEC”; hereinafter, also referred to simply as an edge computer), a 5th generation mobile communication system technology, 5G, and the like. For example, in a plurality of roadside units placed in vicinity to a running road-surface on which an automated driving vehicle runs, obstacle information detected by each of the roadside units is transmitted to an MEC. Considerations have been underway for the MEC by which a reliability value is calculated based on the obstacle information; and so, a braking range of the automated driving vehicle is set in accordance with the aforementioned reliability value.

But on the other hand, considerations on the roadside units described above are not really underway for a specific means or device for acquiring the conditions of a running road-surface and for controlling a vehicle. For example, in a case in which the environments of a running road-surface are changed due to a road-surface freeze, there exists a possibility that, without modifying the aforementioned braking range, a vehicle collides with a forward obstacle due to stoppage of the vehicle, or a possibility that a vehicle may cause lateral rolling or turning in such a case at a curved road-route. In such a case, it has been understood that there arises a problem in degrading the riding comfort when human beings are aboard as passengers, or that there arises a problem in causing the collapse of load or the like when goods are transported.

The present disclosure in the application concerned has been directed at disclosing technologies for solving those problems as described above, an object of the disclosure is to provide a vehicle running-control processing system in which, even on a running road-surface of an automated driving vehicle whose running environments thereon are different, the safety of the running of the automated driving vehicle is secured.

### SUMMARY OF THE INVENTION

### Means for Solving the Problems

A vehicle running-control processing system, comprising:

a roadside unit including a plurality of sensors each for detecting an obstacle and a road-surface condition;

a communications circuitry to receive information on an obstacle being obtained by said roadside unit and information on a road-surface condition being obtained thereby;

a reliability determinator for determining, on bases of information on an obstacle being received by the communications circuitry and information on a road-surface condition being received thereby, a degree of reliability of information on an obstacle being received thereby, based on a number of sensor or sensors in one roadside unit detecting an identical obstacle, on a number of roadside unit or roadside units detecting an identical obstacle, and on a distance between detection points determining an identical obstacle between different sensors or between different roadside units; and

a road-surface condition determinator for determining a condition of a running road-surface of a vehicle on a basis of information on said road-surface condition, and the vehicle running-control processing system further comprising

a vehicle including:
a computer for storing geographic road-map information in advance;
a host-vehicle location detector for detecting a location of a host vehicle; and
an automated driving module including a processor to execute a program and a memory to store the program which, when executed by the processor, performs processes of setting a running road-route of the host vehicle, for modifying a target road-route of the host vehicle determined from the geographic road-map information, based on a running road-route being set by the processor to execute the program and the memory to store the program, wherein

a braking distance of the host vehicle reaching through to an obstacle is corrected on a basis of a braking distance of the host vehicle determined from information on a road-surface condition determined by the road-surface condition determinator, and on a basis of said degree of reliability outputted from the reliability determinator; and a target road-route determined by the automated driving module is changed on a basis of said braking distance of the host vehicle being corrected thereon.

### Effects of the Invention

According to the vehicle running-control processing system disclosed in the disclosure of the application concerned, it becomes possible to provide a vehicle running-control processing system in which the safety of the running of an automated driving vehicle is secured even on a running road-surface of the automated driving vehicle whose running environments thereon are different.

### BRIEF DESCRIPTION OF DRAWINGS

The foregoing and other objects, features, aspects and advantages of the present disclosure in the application concerned will become more apparent from the following detailed description of the present disclosure when taken in conjunction with the accompanying drawings.

FIG. 1 is a diagram illustrating an example of a configuration of a vehicle running-control processing system according to Embodiment 1;

FIG. 2 is an illustrative diagram for explaining in detail a data gathering infrastructure device being a constituent element of the vehicle running-control processing system of FIG. 1;

FIG. 3 is an illustrative diagram for explaining in detail an MEC being a constituent element of the vehicle running-control processing system of FIG. 1;

FIG. 4 is an illustrative diagram for explaining in detail a vehicle being a constituent element of the vehicle running-control processing system of FIG. 1;

FIG. 5 is an illustrative diagram for explaining each of view angles of roadside units used as constituent elements of the data gathering infrastructure device;

FIG. 6A and FIG. 6B are diagrams illustrating a divided flowchart separately for explaining the operations of reliability determination in the vehicle running-control processing system of Embodiment 1;

FIG. 7A and FIG. 7B are diagrams illustrating a divided flowchart separately for explaining the operations of an automatic control based on reliability values in the vehicle running-control processing system of Embodiment 1;

FIG. 8 is an illustrative diagram for explaining in detail an MEC being a constituent element of a vehicle running-control processing system of Embodiment 2;

FIG. 9 is an illustrative diagram for explaining in detail a vehicle being a constituent element of the vehicle running-control processing system of Embodiment 2; and

FIG. 10 is a diagram showing an example of a processor and that of a storage device which are included in each of the devices constituting the vehicle running-control processing system of Embodiment 1 and that of Embodiment 2.

### DETAILED DESCRIPTION OF THE PREFERRED EMBODIMENTS

Hereunder, preferred embodiments according to the present disclosure will be described in detail with reference to the accompanying drawings. Note that, in each of the figures, the same reference numerals and symbols designate the same items as, or the items corresponding to, those shown in the drawings.

### Embodiment 1

The present disclosure in the application concerned relates to a vehicle running-control processing system which is an automated driving system of coordinated or collaborative infrastructure type, and is the vehicle's running-control processing system for controlling a vehicle based on a reliability value (also referred to as a “numerical value of reliability”) calculated from infrastructure's information.

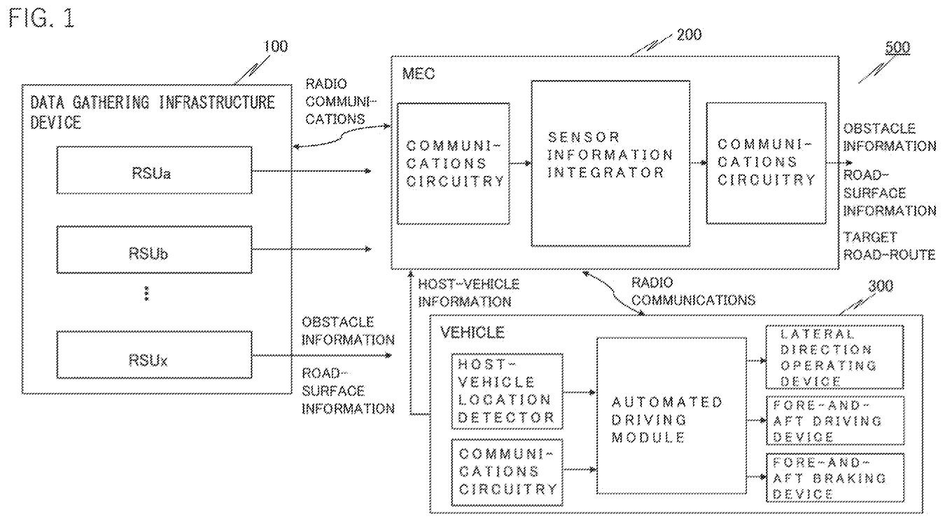

FIG. 1 is a diagram illustrating an example of a configuration of a vehicle running-control processing system according to Embodiment 1. The vehicle's running-control processing system is a vehicle running-control processing system 500 being an automated driving system of coordinated or collaborative infrastructure type constituted of a data collecting or data gathering infrastructure device 100 including a plurality of roadside units (RSUs as RSUa, RSUb, . . . , RSUx), a multi-access edge computer (Multi-access Edge Computer, MEC) 200, and a vehicle 300 on which an advanced driving assistance system (Advanced Driving Assistance System, ADAS) or an automated driving (Automated Driving, AD) system is mounted.

The telecommunications between the aforementioned data gathering infrastructure device 100 and the aforementioned MEC 200 are usually performed through a wireless or radio communications network such as Long-Term Evolution (LTE) or a 5th Generation Mobile Communication System (5G), or through another dedicated communications network. In addition, the telecommunications between the MEC 200 and the vehicle 300 are also performed similarly by way of a radio communications network in high speed with low delay which is representative of the LTE or the 5th Generation Mobile Communication System (5G), or by way of another dedicated communications network.

The aforementioned data gathering infrastructure device 100, the aforementioned MEC 200 and the aforementioned vehicle 300 are each configured by using a processor 400 functioning as a central processing unit (Central Processing Unit, CPU), and a storage device 401 such as a read-only memory (Read-Only Memory, ROM), a random access read-write memory (Random Access Memory, RAM), and the like. In addition, as for the processor described above, it may be made of a digital signal processor (Digital Signal Processor, DSP), or be configured by logic circuits.

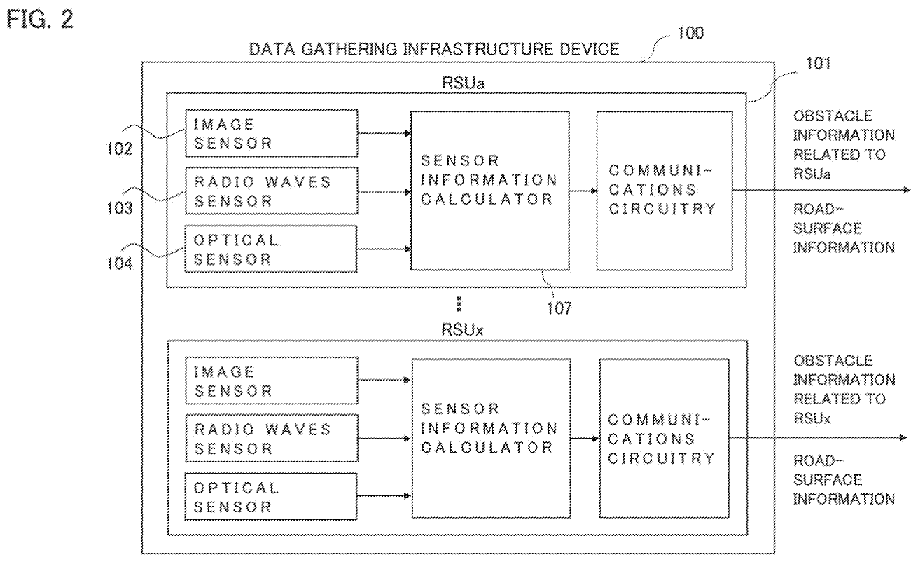

FIG. 2 through FIG. 4 are each illustrative diagrams for explaining in detail each of the constituent elements of the vehicle running-control processing system 500 being the automated driving system of collaborative infrastructure type illustrated in FIG. 1.

FIG. 2 shows the data gathering infrastructure device 100 including a plurality of roadside units RSUa, . . . , RSUx (hereinafter, these roadside units are referred to collectively as a “roadside unit 101, or RSU 101”). Each of the roadside units is constituted of an image sensor(s) 102 for detecting an obstacle, an electromagnetic or radio waves sensor(s) 103 therefor, and an optics or optical sensor(s) therefor. In any one of the sensors, software for carrying out the operations of each of CPUs and that for carrying out the operations of each of the RSUs are stored in the storage device described above, and respective pieces of sensor data are held in the storage device.

In the aforementioned image sensor(s) 102 according to a manner representative of a frontward monitoring camera, for example, an obstacle is picked up as an image, and then, the distance to the obstacle is calculated from image data having been picked up at a constant angular field of visibility, or constant view angle. Moreover, in the aforementioned image sensor(s) 102, information of road-surface environments where the aforementioned vehicle 300 runs is acquired. As an example of the road-surface environments, they include friction of a road-surface on which the vehicle 300 runs, and/or the information such as bosses and recesses on a road-surface. In addition, in the aforementioned radio waves sensor(s) 103 according to a manner representative of a millimeter-wave radar (MMWR) sensor, for example, information on a location of an obstacle within a constant field of view and, in addition to that, a speed of the obstacle within the field of view are directly calculated by means of the Doppler effect. Moreover, in the optical sensor(s) 104 according to a manner representative of a LiDAR sensor(s), for example, an optical laser is irradiated within a constant field of view, and also, point-cloud data obtainable by means of reflection of the laser from an obstacle(s) is detected. In addition, by making use of information of the point cloud reflected from a running road-surface, performed is detection of the information on the road-surface related to road-surface states such as a state of bosses and recesses on a road-surface, and a wet state on the road-surface.

Note that, frictional resistance of the road-surface is set on the basis of the aforementioned information on the road-surface having been detected by the aforementioned RSU 101. Stored therefor in advance are setting vales, for example: in a case in which the RSUa detects a paved good and smooth road-surface with asphalt, the coefficient of friction on the road-surface is at 0.75; in a case of a paved wet road-surface with asphalt, at 0.5; in a case of a snowy road-surface, at 0.15; and, in a case of a frozen road-surface, at 0.07. These setting vales are referred to, and a relevant one is outputted into the MEC 200 as road-surface information of the RSUa. Note that, the processing is provided not only with the RSUa, but also with all of the RSUs, so that the road-surface information is calculated in each of the RSUs.

In the aforementioned RSU 101, a detection signal(s) outputted from the aforementioned image sensor(s) 102, that from the aforementioned radio waves sensor(s) 103 and that from the aforementioned optical sensor(s) 104 are collectively processed in a manner in which those respective outputs from the sensors undergo a single operation. In a sensor information calculator 107, noise information in detection signals inputted form the group of sensors is eliminated, and a plurality of pieces of sensor information is collectively processed by the single operation, whereby, on the periphery in the environments capable of measuring a distance(s) at a view angle of the RSU 101, it becomes possible to perform determination of the presence or absence of an obstacle with higher reliability, and/or to perform identification of the obstacle therewith. For example, an obstacle is distinguished or identified based on a sensor fusion process which enhances the reliability of positional or locational accuracy of an obstacle by processing different pieces of sensor information, and/or based on reinforcement learning such as deep learning.

According to the manners of processing described above, in the aforementioned sensor information calculator 107, acquired based on a plurality of pieces of sensor information outputted from the RSUa are: for example, obstacle information including locational information such as the latitude of an obstacle and the longitude thereof, the speed of the obstacle and the height of the obstacle, and the obstacle information further including distinguished or identified information in which the obstacle belongs in what kind of an obstacle(s) among a vehicle, a pedestrian and/or a motorcycle; and also, road-surface information detected by the RSUa. Note that, these kinds of processing are provided not only with the RSUa, but also with all of the RSUs, so that the obstacle information having been calculated by each of the RSUs and the road-surface information having been calculated thereby are transmitted to the MEC 200.

In addition, in each of the aforementioned RSUs, a detection method by a sensor(s), an identification method thereby and/or the information being capable of sensing the coefficient of friction on a road-surface or the like are not limited to those methods and pieces of information described above. Moreover, in addition to the information from the aforementioned sensor(s) and to the road-surface information therefrom described above, it is possible to combine with another sensor or other sensors which provide traffic flow detection and/or weather detection as the occasion requires.

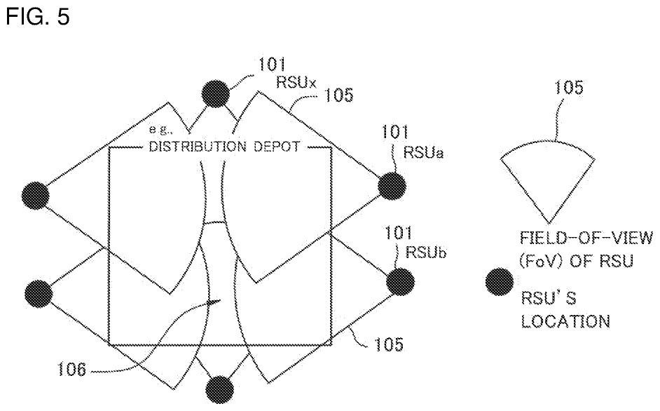

In FIG. 5, a placement example of the RSU 101 is shown. Each of the sensors (102, 103, 104) in the RSU 101 (RSUa, RSUb, . . . , RSUx) has a field of view 105, so that pieces of obstacle information are collected or gathered on the basis of road-surface information. In Embodiment 1, it is so arranged that each of the RSUs has the same specifications in relation to the aforementioned field of view 105, a detection range, and the like. In addition, the RSU 101 is placed so that there exists no area as much as possible on the periphery which becomes a blind spot with respect to a driving or running area 106 which is the area being aimed or targeted for sensing (the area is also referred to as a “target area” 106). To be specific, in order to arrange the aforementioned field of view 105 which resides on a running road-route of a vehicle, it is necessary to determine the placement of the RSU 101 so that at least two RSUs can simultaneously include the identical obstacle or the identical vehicle in the detection range.

Note that, it is also possible for the aforementioned RSU 101 to have different fields of view and their detection ranges. For example, the data gathering infrastructure device 100 may also be suitable for a configuration combining an RSU having a wide field of its view in accordance with a short detection range and another RSU having a long detection range though a field of its view is narrower. According to such a combination, an effect can be expected in which detection accuracy with respect to an obstacle or identification accuracy with respect thereto can be enhanced by limiting an area of the obstacle to its specific area, and/or an effect can be expected in which erroneous detection related to obstacle information due to noise elimination is curbed.

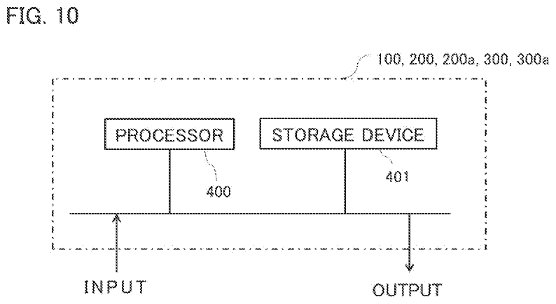

As illustrated in FIG. 1 and FIG. 2, the MEC 200 described above receives obstacle information from the RSU 101, and road-surface information therefrom as described above. In the aforementioned MEC 200, a central processing unit (CPU) and a storage device for storing data for the CPU and processing instructions therefor are included as the CPU and the storage device having been stated above, though they are not visually illustrated in FIG. 1 and FIG. 2 (refer to FIG. 10).

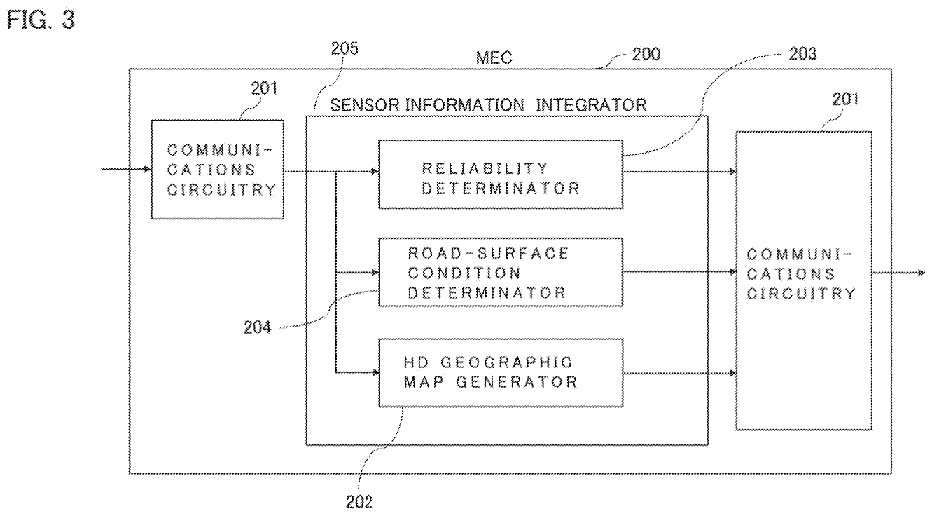

The MEC 200 described above comprises a communications circuitry 201 to perform high speed communications with the aforementioned RSU 101, and a sensor information integrator 205, as illustrated in FIG. 3. The aforementioned communications circuitry 201 receives obstacle information including the presence or absence of an obstacle(s), and a location(s) thereof and a detection time(s) thereof from the aforementioned data gathering infrastructure device 100, and stores the aforementioned obstacle information into the storage device 401. In addition, the aforementioned MEC 200 also receives information related to a sensor status(es) from the RSU 101. Further in addition, the communications circuitry 201 receives locational information such as the latitude of the aforementioned vehicle 300 and the longitude thereof, and information on the speed of the vehicle 300.

In addition, the sensor information integrator 205 of the aforementioned MEC 200 comprises a reliability determinator 203 for determining the degree of reliability of obstacle information having been received (refer to FIG. 3). The reliability determinator 203 determines the degree of reliability of obstacle information having been detected, and output a reliability value which quantitatively indicates the degree of reliability of the obstacle information. As for the reliability value, the combination is performed on: determination based on whether or not the aforementioned image sensor(s) 102 in each of the RSUs, the aforementioned radio waves sensor(s) 103 therein and the aforementioned optical sensor(s) 104 therein are suitably functioning, or determination based on a sensor status(es); determination based on whether or not a plurality of RSUs verifies detection of the same obstacle; and determination based on whether or not a plurality of sensors existing in the same RSU detects the same obstacle, namely, whether or not an image sensor(s) 102 of one RSU, a radio waves sensor(s) 103 of the one RSU and an optical sensor(s) 104 of the one RSU (hereinafter, also referred to collectively as an advanced driving assistance system (ADAS) sensor(s), or “ADAS sensor(s)”) detect the same obstacle. Accordingly, the reliability value is determined after the combination having been performed on each other, and is outputted into the aforementioned communications circuitry 201.

Next, the explanation will be made in detail for the reliability value. In a case in which a plurality (the number of “n”) of RSUs detects the same obstacle with respect to one obstacle, detection points exist in the number of “n” with respect to the identical subject-matter or object. As for detection points of the number of “n” described above, there may be a case producing detection errors (positional or locational errors) originated as a cause in detection errors of a sensor(s) and/or as a cause in detection faces from an obstacle which are different from each other, even when the obstacle is the identical obstacle.

As for a scheme in which the identical obstacle is determined as it is from the detection points of the number of “n” described above, and in which these detection points are made as a group by grouping them, there are various kinds of schemes (stochastic schemes). Herein, the difference between distances of those detection points between themselves is calculated, and determination of an obstacle(s) being aimed or targeted is performed. Here, a difference value “δ” of the distances of those detection points between themselves is acquire according to Expression (1).

[Expression Figure-1]

δ+\sqrt{(x₁−x₂)²+(y₁−y₂)²} (1)

Here, two detection points are expressed by (x₁, y₁) and (x₂, y₂).

And then, in a case in which the aforementioned difference value “δ” exists within a constant threshold value, determination is performed on the detection points so that they belong to the identical obstacle. By determining as described above, the degree of reliability of detection becomes the highest, and thus, on this occasion, a reliability value “4” is outputted.

Next, in a case in which only one RSU detects an obstacle and in which the same obstacle is detected from the aforementioned ADAS sensors in the same RSU, a reliability value is not higher in comparison with the case in which a plurality of RSUs described above detects an obstacle; however, on this occasion, it is determined that the degree of reliability is high, so that a reliability value “3” is outputted.

Next, when only one sensor among the ADAS sensors among the RSUs detects an obstacle, the degree of reliability is further lowered; however, on this occasion, a reliability value “2” is outputted.

In addition, in a case in which a sensor status(es) indicates “normal” and in which no obstacle is detected at all on a running road-route, a reliability value “1” is outputted; meanwhile, in a case in which a sensor(s) does not function due to a factor of a malfunction or the like, or a case in which abnormality of wireless or radio communications is caused, a reliability value is outputted.

Next, in a road-surface state or road-surface condition determinator 204, the coefficient of friction on a running road-route of the aforementioned vehicle 300 is set on the basis of road-surface information outputted from the RSU 101. When a road-surface is detected by means of a plurality of RSUs, there exists a case in which their detection ranges are duplicated or overlapped on each other. In such a case, a mean value of road-surface information being received from each of the RSUs is acquired with respect to a running road-route whose detection ranges are duplicated or overlapped on each other.

In an HD geographic map generator 202 (here, an “HD” stands for a “hard disk”), a target road-route provided with geographic road-map information along which the aforementioned vehicle 300 runs is outputted, based on the geographic road-map information having been stored in advance. In addition, the aforementioned HD geographic map generator 202 transmits, through the communications circuitry 201, the geographic road-map information on a vehicle (host vehicle) in vicinity to the host vehicle (for example, 500 meters in its frontward direction, and 500 meters in its rearward direction). A range of the geographic road-map can be changed based on a vehicle speed; and so, the higher the vehicle speed is, the wider the range can be changed.

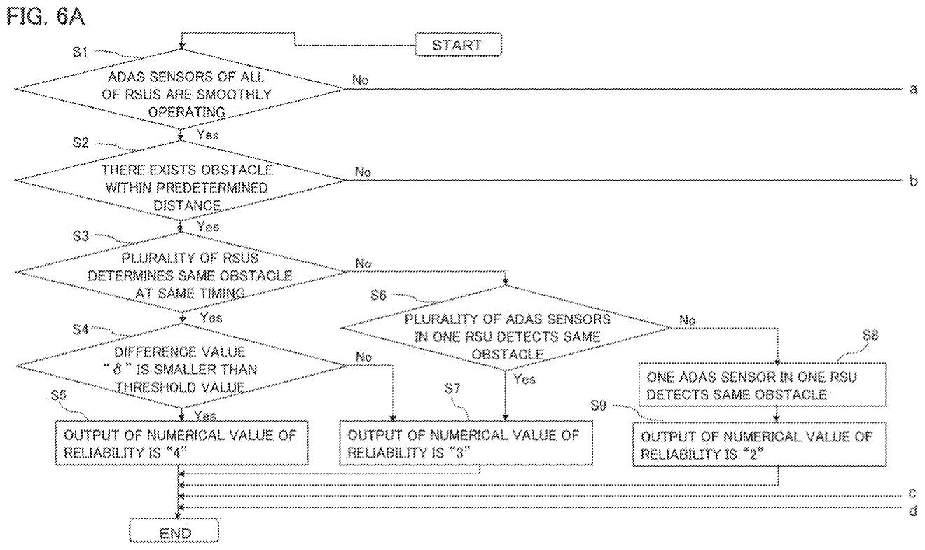

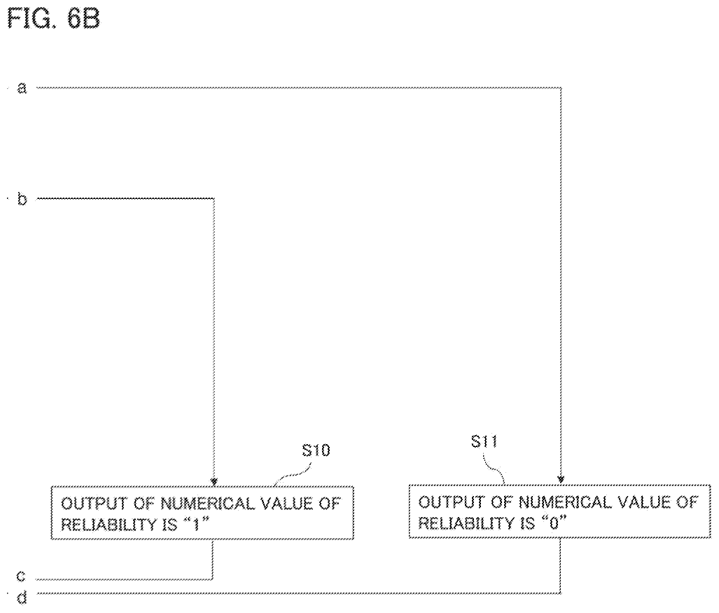

FIG. 6A and FIG. 6B are diagrams illustrating a divided flowchart separately, where symbols a, b, c, d are interconnection points of the flow in the flowchart, for showing the processing being executed by the aforementioned reliability determinator 203. The aforementioned reliability determinator 203 receives obstacle information from the RSU 101, and thereafter outputs a reliability value (numerical value of reliability) in accordance with the aforementioned flowchart.

First, determination is performed whether or not any one of ADAS sensors is suitably functioning, namely, whether or not effective sensor data can be acquired (Step S1). In a case in which a sensor(s) is not functioning to provide effective data, a numerical value of reliability “0” is outputted (Step S11).

In a case in which the sensors are effectively functioning to do so, determination is performed whether or not there exists an obstacle of some kind within a predetermined distance(s) from the vehicle (Step S2). In a case in which an obstacle is not detected within the predetermined distance(s), a numerical value of reliability “1” is outputted (Step S10).

Next, when obstacle information is outputted into the reliability determinator 203 in a state in which an obstacle exists within the predetermined distance(s) and also in a state in which the sensors are effectively functioning, determination is performed whether or not the same obstacle is detected on the bases of obstacle information from at least two RSUs at the same timing (Step S3).

In addition, in a case in which the same obstacle is detected at the same timing by at least two RSUs, for example, by the RSUa and RSUb, a location of the obstacle detected from the aforementioned RSUa and that of the aforementioned RSUb are compared. Namely, as described above, difference values “δ” each calculated from the location of respective obstacle are acquired, and are compared with a threshold value(s) of arbitrarily predetermined difference(s).

Note that, when detection timing of an obstacle differs due to the difference between sampling frequencies of respective sensors, calculation accuracy of the aforementioned difference value is enhanced by interpolating a location of the obstacle on the basis of a velocity vector of the obstacle, and/or on the basis of a detection time thereof.

After the aforementioned difference value “δ” has been acquired, the difference value is compared with a threshold value of a predetermined difference (Step S4). In a case in which the difference value “δ” is smaller than a predetermined threshold value, determination is performed in which the degree of reliability is high, so that a numerical value of reliability is set at “4” (Step S5). Therefore, in a case in which a plurality of RSUs detects the same obstacle existing within the threshold value of the difference, a stochastic accuracy of the detection information is high, so that it can be said that the degree of reliability is high. Meanwhile, in a case in which a difference value “δ” exceeds the threshold value of the difference, the numerical value of reliability “3” is outputted, even when the obstacle is identical (Step S7).

In a case in which a plurality of RSUs does not detect the same obstacle (Step S3), determination is performed whether or not ADAS sensors provided with one RSU detect the same obstacle (Step S6). In a case in which a plurality of ADAS sensors from the same RSU detects the same obstacle, the reliability of the sensors is positively verified; however, because of the detection result of the single RSU, the numerical value of reliability “3” is outputted (Step S7).

Meanwhile, in a case in which only one sensor among the plurality of ADAS sensors detects an obstacle (Step S8), the degree of reliability is lowered, so that the numerical value of reliability “2” is outputted (Step S9).

According to the above, a reliability value is set based on a status(es) of an RSU(s) for verifying detection of an obstacle(s), and/or based on errors in detections between locations of an obstacle made by between at least two RSUs, and/or based on the number of a sensor(s) in one RSU for verifying detection of the same obstacle; and then, the aforementioned reliability value, obstacle information and a target road-route are transmitted from the aforementioned MEC 200 to the aforementioned vehicle 300 through the communications circuitry 201.

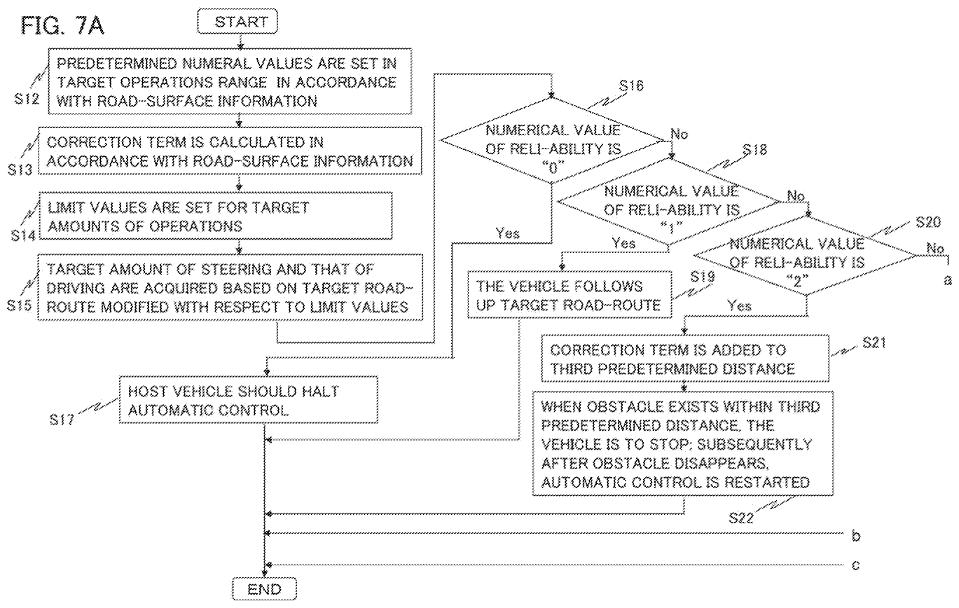

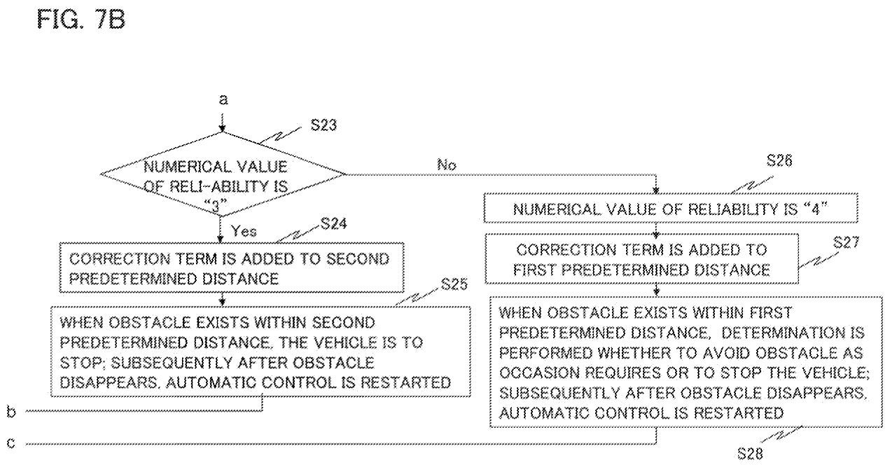

In the aforementioned vehicle 300, received thereby are a reliability value outputted by the aforementioned reliability determinator 203, obstacle information, road-surface information determined by the road-surface condition determinator 204 and a target road-route calculated by the HD geographic map generator 202; and afterward, an automatic control on the bases of road-surface information and a reliability value is performed in accordance with a flowchart (FIG. 7A and FIG. 7B) as will be described later.

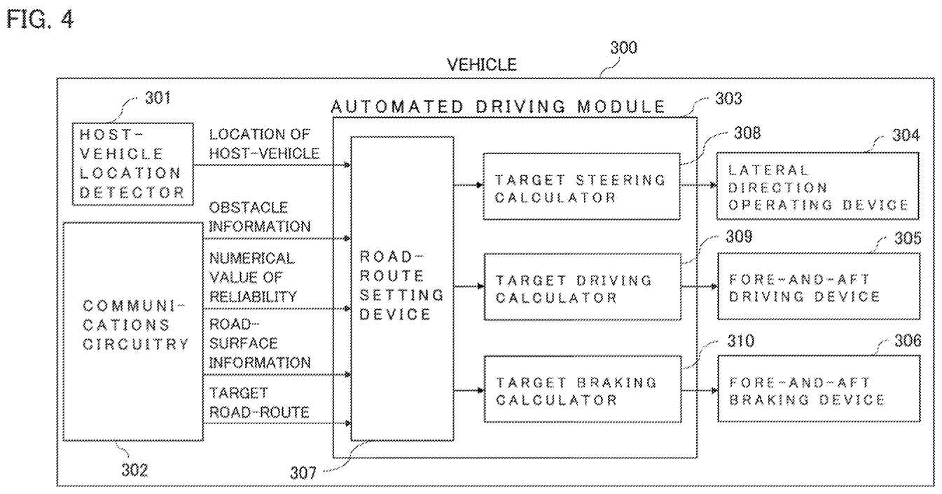

As illustrated in FIG. 4, the aforementioned vehicle 300 includes a host-vehicle location detector 301 for acquiring or detecting a location of host-vehicle, a communications circuitry 302 and an automated driving module 303; and the vehicle 300 receives, by way of the communications circuitry 302, the aforementioned obstacle information, the aforementioned reliability value, the aforementioned road-surface information and the aforementioned target road-route, which are inputted into the automated driving module 303 of the vehicle. The aforementioned automated driving module 303 comprises a road-pathway or a processor to execute a program and a memory to store the program which, when executed by the processor, performs processes of setting a running road-route of the host vehicle 307 (hereinafter, also referred to as “a road route setting device 307” in simplified terms) for restricting or limiting the running of vehicle, and corrects or modifies the aforementioned target road-route based on limit values in a vehicle control range having been set by the aforementioned the road-route setting device 307. As for the limit values described above, there exist a target quantity of or target amount of steering inputted into a target steering calculator 308, a target quantity of or target amount of driving inputted into a target driving calculator 309, and a target quantity of or target amount of braking inputted into a target braking calculator 310; and so, these amounts are referred to collectively as the “target amounts of operations.”

In the target steering calculator 308 described above, for example, a target steering angle (angle of targeted steering), target torque or the like is set as a target amount of steering; and the target steering calculator comprises a controller for executing a feedback control, a feedforward control or a control combining with these controls so that, by each of which, the aforementioned target amount of steering is followed up. And then, a lateral direction operating device 304 operates in accordance with an output value(s) from the target steering calculator 308. As an example of constituent elements of the lateral direction operating device 304 described above, electric power steering attached with a steering angle sensor and an electric power steering controller for controlling the revolutions of the aforementioned electric power steering can be named; and so, by providing with these constituent elements on a vehicle, the configuration is achieved to perform the control for following up a target steering angle, a target angular velocity or differential values of these.

As a target quantity of or target amount of driving calculated by the target driving calculator 309 described above, for example, a target vehicle-speed, target acceleration, or a target degree of jerk (a target of increasing acceleration or hard acceleration; here, “hard acceleration” means the rate of change of acceleration per the unit hour), target driving torque and/or the like can be named; and the target driving calculator comprises a controller for executing a feedback control, a feedforward control or a control combining with these controls so that, by each of which, the aforementioned target amount of driving is followed up. A fore-and-aft driving device 305 operates in accordance with an output value(s) from the target driving calculator 309. As an example of constituent elements of the fore-and-aft driving device 305, electric motors, each provided with rotation sensors, in use for driving a vehicle and inverters for controlling the revolutions of the aforementioned electric motors in use therefor can be named; and so, by providing with these constituent elements on the vehicle, the configuration is achieved to perform the control for following up target fore-and-aft distances, a target vehicle-speed, or differential values of these.

As a target quantity of or target amount of braking calculated by the target braking calculator 310 described above, for example, braking pressure can be named; and the target braking calculator comprises a controller for executing a feedback control, a feedforward control or a control combining with these controls so that, by each of which, the aforementioned target amount of braking is followed up. A fore-and-aft braking device 306 operates in accordance with an output value(s) from the target braking calculator 310. As an example of constituent elements of the fore-and-aft braking device 306, an oil-hydraulic brake and a control circuitry to control the pressure of the aforementioned oil-hydraulic brake can be named; and so, by providing with these constituent elements on a vehicle, the configuration can be achieved to perform the control for following up target braking pressure.

By referring to the flowchart of FIG. 7A and FIG. 7B, where symbols a, b, c are interconnection points of the flow in the flowchart, the explanation will be made for specific vehicle controls according to Embodiment 1. First, a first predetermined distance (L1), a second predetermined distance (L2) and a third predetermined distance (L3) are defined. Here, there exists the relationship “L1<L2<L3” to be held at one another. As for predetermined distances indicated by the aforementioned distances L1 to L3, the higher a reliability value (numerical value of reliability) is, the shorter the distance is shifted. That is to say, when a reliability value becomes higher, the selection to take on from L3 to L2 and that to take on from L2 to L1 are made in accordance with the reliability value.

Note that, the predetermined distances described above are not limited in fore-and-aft directions, but are also applicable in horizontal or lateral directions; and so, it may be adopted that first to third predetermined distances in the fore-and-aft directions and respective first to third predetermined distances in the lateral directions are set, and that those setting values are set by being combined with each other.

When the flows of FIG. 7A and FIG. 7B are started, limit values of target amounts of operations are set by the road-route setting device 307 in accordance with road-surface information (Step S12). Next, a modification or correction term is calculated in accordance with the road-surface information (Step S13).

As for a correction term described above, a braking distance is calculated from the road-surface information of the coefficient of friction on a road-surface, and the quantity of change from a value of a braking distance on a running road-route in a case of an ordinary road-surface is outputted as the correction term.

It may also be adopted that the aforementioned correction term is calculated by taking into consideration of vehicle information including the internal air pressure of each of tires fitted with a vehicle and/or including the information on aging such as their age degradation, in addition to the consideration of the road-surface information. These pieces of information are obtained by means of sensors (not shown in the figures) mounted on a vehicle. Here, the coefficient of friction of tires each fitted with the vehicle is susceptible to the influence of the internal air pressure of each of the tires, to their age degradation or the like, and thus, the coefficient of friction is not necessarily constant. For dealing therewith, it is possible to provide an automated driving system in which, by acquiring a correction term through the calculation based on information of the vehicle concerned, estimation accuracy in a stoppage distance of the vehicle is enhanced, so that collision probability of the vehicle is further reduced.

In FIG. 7A and FIG. 7B, an initial value is set at a target vehicle speed (Step S14), and a steering angle and the target vehicle speed are adjusted based on a shape(s) of a target road-route (Step S15). The initial target speed described above is controlled from an initial value based on a condition(s) of a target road-route, namely, based on a parking condition, the curvature of the target road-route and/or the like.

Here, when a numerical value of reliability is at “0” (Step S16), automated driving of the vehicle is not permitted (Step S17). This indicates that a sensor status cannot be received due to a factor in which an RSU(s) malfunctions. In order to achieve this, an automated driving control of the aforementioned vehicle 300 does not operate, or the automated driving control is halted.

Next, in a case in which the numerical value of reliability is at “1” (Step S18), an obstacle is not detected by means of any one of RSUs, nor by means of any one of the aforementioned ADAS sensors. Therefore, it is determined that, within a field of view of the RSU 101, no obstacle exists upon a running road-route of the vehicle 300 described above, so that the aforementioned vehicle 300 undergoes its automatic control in accordance with the aforementioned target amounts of operations calculated from a target road-route (Step S19).

Here, the aforementioned automatic control designates that, as exactly described above, a target amount of steering calculated from a target road-route is modified in the road-route setting device 307 on the bases of road-surface information outputted from the aforementioned communications circuitry 302 and the target road-route outputted therefrom. For example, in a case of a road-surface condition such as a freeze which differs from an ordinary condition, the maximum steering angle is made reduced in order to prevent lateral rolling or turning.

In addition, in a case in which there exists a curved road-route, a range of the maximum steering angles and/or that of steering angular velocities or steering angular speeds are set by taking the curvature of road into consideration, and meanwhile, a vehicle-speed is set so as to be lowered through the road-route setting device 307, so that the vehicle continues to run on the curved road-route. According to the measures being taken as described above, lateral rolling or turning is curbed to be caused in particular at the curved road-route on and along the target running road-route.

In addition, while it is not diagrammatically shown in the figures, a means or device being capable of detecting a skid or slip rate(s) of tires is provided for the vehicle; thus, it is arranged in such a manner that a target slip rate(s) is changed in accordance with the road-surface information, and that a target quantity of or target amount of driving is set by the target driving calculator 309 so as to achieve the aforementioned target slip rate(s) or less. According to this arrangement, skids or slippage of a tire(s) can be suppressed, so that the skids or slippage of the vehicle can be suppressed to be caused even for the running under the road-surface environments in such a case as the running on a frozen road, or that on hills with slopes in rain; and thus, it becomes possible to achieve enhancing the comfortableness to a vehicle's occupant(s).

Moreover, it may also be adopted that a target quantity of or target amount of braking is reduced by the target braking calculator 310 on the basis of road-surface information. For example, in a case in which a vehicle is to stop heading toward traffic lights or toward a point of location to stop the vehicle, a target amount of braking residing in the road-route setting device 307 is lowered, and the vehicle is smoothly decelerated so as to be stopped at the target point of location. Because there exists the road-surface information, the stoppage of the vehicle can also be smoothly performed, and further, it becomes also possible to achieve a precise stoppage to the target point of location.

In a case in which the numerical value of reliability is at “2,” namely, when it is indicated that one sensor of one RSU detects an obstacle (“Yes” at Step S20), the automated driving module 303 first calculates a stoppage distance of running by adding a correction term calculated at Step S13 together with the third predetermined distance (Step S21). In a case in which there exists an obstacle which is to obstruct automated running of the aforementioned vehicle 300 within a distance capable of vehicle's running as described above, an automatic control is performed so that the vehicle 300 is to stop. Subsequently, in a case in which the aforementioned obstacle moves away and the obstacle exists no more, automated driving is permitted for a second time, and the automatic control is enabled or restarted (Step S22).

In a case in which the numerical value of reliability is at “3,” namely, in a case in which a plurality of ADAS sensors of one RSU detects the same obstacle (“Yes” at Step S23), the automated driving module 303 calculates a stoppage distance of vehicle's running by adding a correction term calculated at Step S13 together with the second predetermined distance (Step S24). In a case in which there exists an obstacle which is to obstruct automated running of the aforementioned vehicle 300 within a distance capable of running as described above, the automatic control is performed so that the vehicle 300 is to stop. Subsequently, in a case in which the aforementioned obstacle exists no more in vicinity to the aforementioned vehicle 300, automated driving is permitted for a second time, and the automatic control is enabled or restarted (Step S25).

In a case in which the numerical value of reliability is at “4” (Step S26), namely, in a case in which a plurality of RSUs detects the same obstacle (“No” at Step S23), the aforementioned automated driving module 303 calculates a stoppage distance of vehicle's running by adding a correction term calculated at Step S13 together with the first predetermined distance (Step S27). In a case in which there exists an obstacle which is to obstruct automated running of the aforementioned vehicle 300 within a distance capable of running as described above, the automatic control is performed so that the vehicle 300 is to stop. Subsequently, in a case in which the aforementioned obstacle exists no more in vicinity to the aforementioned vehicle 300, automated driving is permitted for a second time, and the automatic control is enabled or restarted (Step S28).

As described above, the automated driving module 303 controls a vehicle speed and vehicle steering so that the vehicle avoids an obstacle or the vehicle stops to avoid it, depending on whether or not the vehicle can avoid the obstacle. When a reliability value (numerical value of reliability) indicates that an obstacle is detected and also that a plurality of sensors from only one roadside unit (RSU) detects the obstacle, the automated driving module 303 controls the vehicle speed so as to stop the vehicle when it is approaching toward the obstacle within a second predetermined distance. The control can be resumed or restarted when an obstacle is to be nonexistent.

When a reliability value (numerical value of reliability) indicates that an obstacle is detected and also that only one sensor from one roadside unit (RSU) detects the obstacle within a third predetermined distance, the automated driving module 303 controls the vehicle speed so as to stop the vehicle when it is approaching toward the obstacle within the predetermined distance. In the manner described above, a third predetermined distance is longer than a second predetermined distance, and the second predetermined distance is longer than a first predetermined distance.

Here, the first predetermined distance, the second predetermined distance and the third predetermined distance are distances in which a vehicle selects in accordance with a numerical value of the degree of reliability to detect an obstacle. In a case in which the degree of reliability of a sensor(s) is at the highest, a running stoppage range specified by the first predetermined distance becomes the shortest. That is to say, because the distance between the vehicle 300 and an obstacle in a frontward direction of the aforementioned vehicle can be shortened, the degree of transportation efficiency can be achieved in the best state.

According to the above, a distance capable of running can be made variable in accordance with a reliability value, and the automated driving can be continued without having contact with an obstacle(s) even in an automated driving vehicle on which a sensor(s) is not mounted; and at the same time, the automatic control of the vehicle is performed in accordance with road-surface environments, whereby, even when there exists a change(s) on and along a running road-route, effects are achieved in reducing the risk of collision between vehicles themselves, and in enhancing the riding comfort of a vehicle's occupant(s).

Note that, the relationship being “n=5−m” is held at all times between a reliability value “m” and a numeral “n” of a predetermined distance L. In the present disclosure in the application concerned, the maximum reliability value is set at “4,” so that a predetermined distance(s) being set takes on the numeral “1” (among L1 to L3). Note that, there is no intension to restrict the maximum reliability value at “4”; and so, the value is a numeric value or a number which can be changed by design personnel. It is suitable to set the maximum reliability value and the number of predetermined distances so that the relationship being “n=5−m” is held at all times. According to the setting described above, it is possible to obtain those effects similar to the effects of the present disclosure in the application concerned.

### Embodiment 2

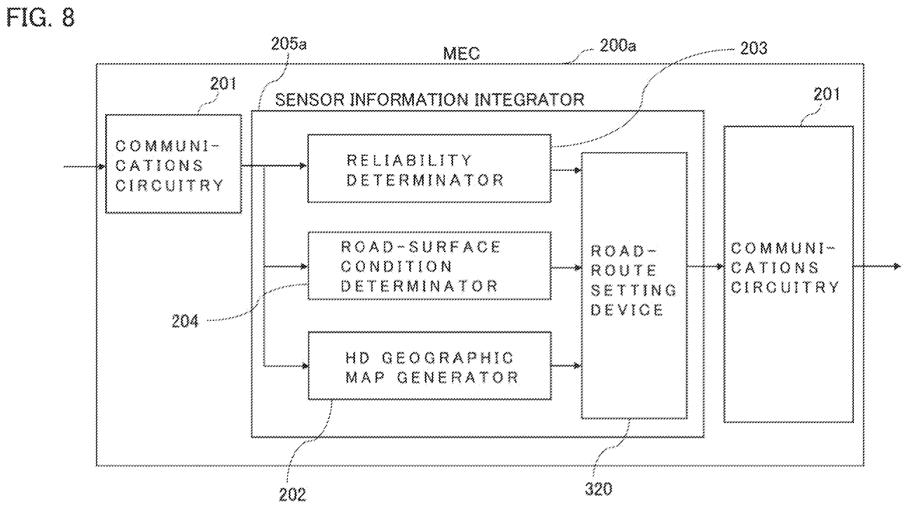

In FIG. 8, an illustrative diagram is shown for explaining in detail a multi-access edge computer MEC 200a according to Embodiment 2. As exactly shown in FIG. 8, the aforementioned MEC 200a comprises the communications circuitry 201 for performing high speed communications with the aforementioned RSU 101. Through the aforementioned communications circuitry 201, the MEC 200a receives obstacle information detected by means of each of the RSUs, road-surface information detected thereby, and information on a location of a vehicle 300a. In the aforementioned obstacle information, a location of the obstacle and its detection time are included, which are stored together with the conditions of a road-surface(s) detected as the aforementioned road-surface information by means of each of the RSUs.

Similarly to the manners as set forth in Embodiment 1, in the aforementioned MEC 200a, comprised are the reliability determinator 203 for determining the degree of reliability of obstacle information having been received, the road-surface condition determinator 204 for determining the conditions of a running road-surface on the basis of road-surface information having been received from the RSU 101, and the HD geographic map generator 202 for calculating a target road-route based on geographic road-map information having been stored in advance; and separately from these units, the MEC 200a further comprises a road-pathway or a road-route setting device 320 for setting a running road-route(s) of a vehicle(s) based on signals of these results, so that the MEC 200a newly has another sensor information integrator 205a including those units.

The aforementioned road-route setting device 320 performs the calculation similar to that performed by the road-route setting device 307 according to Embodiment 1. In the road-route setting device 320 described above, the processing is performed in accordance with the flowchart of FIG. 6A and FIG. 6B, and that of FIG. 7A and FIG. 7B, based on the degree of reliability outputted form the reliability determinator 203, road-surface information outputted form the road-surface condition determinator 204, a target road-route outputted form the HD geographic map generator 202, and information on a location of the vehicle 300a received through the aforementioned communications circuitry 201.

In Embodiment 1, the setting of the degree of reliability described in FIG. 6A and FIG. 6B have been performed by the MEC 200, and the calculation of a correction term described in FIG. 7A and FIG. 7B and the automatic control described therein have been performed by the vehicle 300, on the bases of road-surface information and a reliability value or numerical value of the reliability; however, in the configuration according to Embodiment 2, the processing stated above and described in FIG. 7A and FIG. 7B is now performed by the aforementioned MEC 200a. That is to say, the processing is performed by means of the aforementioned MEC 200a up to the determination of target quantities or target amounts, so that the control to follow up those target quantities or target amounts is performed by means of the vehicle 300a as will be described below.

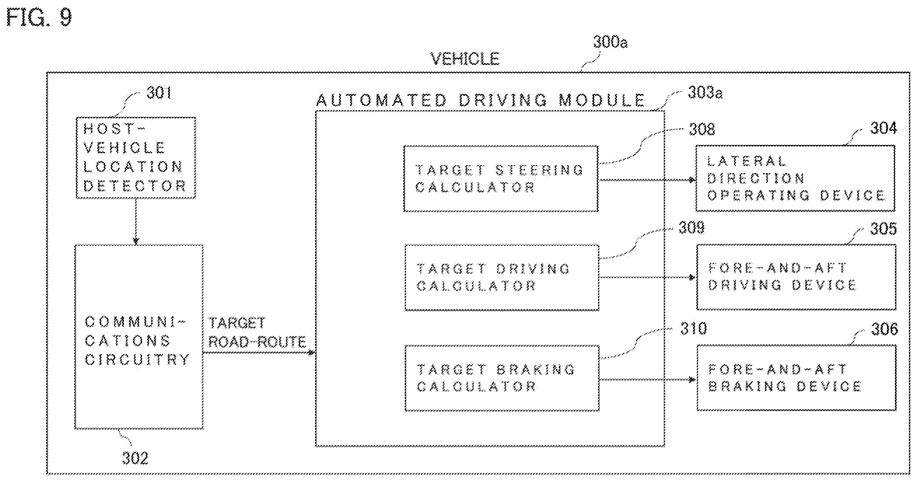

In FIG. 9, a configuration diagram of the vehicle 300a according to Embodiment 2 is illustrated.

Because the vehicle 300a does not perform the determination of a target quantity or target amount, the vehicle 300a does not comprise a road-route setting device, so that the vehicle 300a comprises constituent elements, other than such a road-route setting device, which are: the host-vehicle location detector 301; the communications circuitry 302 to acquire or receive a location of the host vehicle 300a outputted from the host-vehicle location detector 301; an automated driving module 303a having the target steering calculator 308 for calculating a target amount of steering to follow up in accordance with a target road-route, the target driving calculator 309 for calculating a target quantity of or target amount of driving to follow up in accordance with the target road-route, and the target braking calculator 310 for calculating a target amount of braking to follow up in accordance with the target road-route; and the lateral direction operating device 304, the fore-and-aft driving device 305 and the fore-and-aft braking device 306 each of which as an actuator portion for driving the host vehicle 300a in accordance with a respective amount of the operation described above.

That is to say, in the embodiment, the processing for determining a target road-route is achieved by means of the MEC 200a; namely, in accordance with the flows shown in FIG. 7A and FIG. 7B, the MEC 200a achieves the processing on the bases of the degree of reliability and road-surface information for correcting a braking distance, and the processing on the bases thereof for determining the aforementioned target quantities or target amounts; and thus, modification of a target road-route becomes unnecessary on the side of host vehicle.

According to the measures being taken as described above, it is possible to cope with a change(s) in road-surface environments even in a case in which a sensor(s) for the purpose of automated driving is not necessarily mounted on a vehicle, so that, by suitably maintaining a distance for the vehicle capable of achieving its running, an effect is achieved in curbing skids or slippage of the vehicle, or its lateral rolling or turning, and also, an effect is achieved in enhancing the comfortableness to a vehicle's occupant(s).

It should be noted that the configuration of the system in Embodiment 2 is merely an example, and that modifications of the system configuration such as elimination in the system or addition to the system can be made with respect to the system configuration diagram according to Embodiment 1 and that according to Embodiment 2.

To be specific in the manner described above in the embodiments, the explanation has been made based on the premise that the multi-access edge computer MEC is placed outside of the vehicle; however, it is not necessarily limited to this. It may also be so arranged that such an MEC is mounted within the vehicle (inside of it). Note that, in this case, an exchange of the information (data) between the vehicle and the MEC is not necessarily limited to the wireless or radio communications.

Furthermore, the data gathering infrastructure device 100, the MEC 200, the MEC 200a, the vehicle 300 and the vehicle 300a each include a processor 400 and a storage device 401, as an example of the hardware is shown in FIG. 10. The storage device is provided with a volatile storage device of a random access read-write memory (RAM) or the like, and with a nonvolatile auxiliary storage device of a flash memory or the like, which are not shown in the figure. In addition, in place of the flash memory, an auxiliary storage device of a hard disk may be provided with. The processor 400 executes a program(s) inputted from the storage device 401. In this case, the program(s) is inputted into the processor 400 from the auxiliary storage device by way of the volatile storage device. Moreover, the processor 400 may output its data of a calculated result(s) or the like into the volatile storage device of the storage device 401, or may store the data into the auxiliary storage device by way of the volatile storage device.

### EXPLANATION OF NUMERALS AND SYMBOLS

Numeral “100” designates a data gathering infrastructure device; “101,” roadside unit (RSU); “102,” image sensor; “103,” radio waves sensor; “104,” optical sensor; “105,” field of view; “106,” running area (target area); “107,” sensor information calculator; “200,” MEC; “201,” “302,” communications circuitry; “202,” HD geographic map generator; “203,” reliability determinator; “204,” road-surface condition determinator; “205,” sensor information integrator; “300,” “300a,” vehicle; “301,” host-vehicle location detector; “303,” “303a,” automated driving module; “304,” lateral direction operating device; “305,” fore-and-aft driving device; “306,” fore-and-aft braking device; “307,” “320,” processor to execute a program and memory to store the program which, when executed by the processor, performs processes of setting a running road-route of the host vehicle (road-route setting device); “308,” target steering calculator; “309,” target driving calculator; “310,” target braking calculator; “400,” processor; “401,” storage device; and “500,” vehicle running-control processing system.

What is claimed is:

1. A vehicle running-control processing system, comprising:
a roadside unit including a plurality of sensors each to detect an obstacle and a road-surface condition;
a communications circuitry to receive information on an obstacle being obtained by said roadside unit and information on a road-surface condition being obtained thereby;
a reliability determinator to determine, on bases of information on an obstacle being received by the communications circuitry and information on a road-surface condition being received thereby, a degree of reliability of information on an obstacle being received thereby, based on a number of sensor or sensors in one roadside unit detecting an identical obstacle, on a number of roadside unit or roadside units detecting an identical obstacle, and on a distance between detection points determining an identical obstacle between different sensors or between different roadside units; and
a road-surface condition determinator to determine a condition of a running road-surface of a vehicle on a basis of information on said road-surface condition, and the vehicle running-control processing system further comprising
a vehicle including:
a computer to store geographic road-map information in advance;
a host-vehicle location detector to detect a location of a host vehicle; and
an automated driving module including a processor to execute a program and a memory to store the program which, when executed by the processor, performs processes of setting a running road-route of the host vehicle, to modify a target road-route of the host vehicle determined from the geographic road-map information, based on a running road-route being set by the processor to execute the program and the memory to store the program, wherein
a braking distance of the host vehicle reaching through to an obstacle is corrected on a basis of a braking distance of the host vehicle determined from information on a road-surface condition determined by the road-surface condition determinator, and on a basis of said degree of reliability outputted from the reliability determinator; and a target road-route determined by the automated driving module is changed on a basis of said braking distance of the host vehicle being corrected thereon.

2. The vehicle running-control processing system as set forth in claim 1, wherein the processor to execute the program and the memory to store the program sets a running road-route of the host vehicle, on a basis of a road-surface condition calculated by information on an obstacle and by that on said road-surface condition, and on a basis of geographic road-map information calculated thereby.

3. The vehicle running-control processing system as set forth in claim 2, wherein the processor to execute the program and the memory to store the program specifies a maximum steering angle of the host vehicle, and also performs a control to maintain a maximum steering angle of the host vehicle at a predetermined value or less, on a basis of information on said road-surface condition.

4. The vehicle running-control processing system as set forth in claim 2, wherein the processor to execute the program and the memory to store the program specifies a slip rate of a tire of the host vehicle, and also performs a control to maintain a slip rate of the host vehicle at constant, on a basis of information on said road-surface condition.

5. The vehicle running-control processing system as set forth in claim 2, wherein the processor to execute the program and the memory to store the program specifies a running speed of the host vehicle, and also performs a control to maintain a running speed of the host vehicle at a predetermined value or less, on a basis of information on said road-surface condition.

6. The vehicle running-control processing system as set forth in claim 2, wherein the processor to execute the program and the memory to store the program specifies acceleration of the host vehicle, and also performs a control to maintain deceleration of the host vehicle at a predetermined value or less, on a basis of information on said road-surface condition.

7. The vehicle running-control processing system as set forth in claim 2, wherein
the host vehicle includes a sensor capable of detecting a state of a host vehicle's running road-surface, and
said braking distance of the host vehicle is modified on a basis of information on the road-surface obtained by the sensor.

8. The vehicle running-control processing system as set forth in claim 7, wherein
the host vehicle includes a sensor capable of detecting internal air pressure of a tire, and
said braking distance of the host vehicle is modified on a basis of internal air pressure of the tire obtained by the sensor.

9. The vehicle running-control processing system as set forth in claim 2, wherein
the host vehicle includes a storage device to store information on aging of a tire, and
said braking distance of the host vehicle is modified on a basis of the information on aging.

10. A vehicle running-control processing system, comprising:
a roadside unit including a plurality of sensors each to detect an obstacle and a road-surface condition;
a communications circuitry to receive information on an obstacle being obtained by said roadside unit and information on a road-surface condition being obtained thereby, and to receive information on a location of a vehicle;
a reliability determinator to determine, on bases of information on an obstacle being received by the communications circuitry and information on a road-surface condition being received thereby, a degree of reliability of information on an obstacle being received thereby, based on a number of sensor or sensors in one roadside unit detecting an identical obstacle, on a number of roadside unit or roadside units detecting an identical obstacle, and on a distance between detection points determining an identical obstacle between different sensors or between different roadside units;
a road-surface condition determinator to determine a condition of a running road-surface of a vehicle on a basis of information on said road-surface condition; and
a processor to execute a program and a memory to store the program which, when executed by the processor, performs processes of setting a running road-route of a vehicle, and the vehicle running-control processing system further comprising
a vehicle including:
a computer to store geographic road-map information in advance;
a host-vehicle location detector to detect a location of a host vehicle;
another communications circuitry to receive a location of the host vehicle being detected, and to output a target road-route; and
an automated driving module including a processor to execute a program and a memory to store the program which, when executed by the processor, performs modify a target road-route of the host vehicle determined from the geographic road-map information, based on a running road-route being set by the computer, wherein
a braking distance of the host vehicle reaching through to an obstacle is corrected on a basis of a braking distance of the host vehicle determined from information on a road-surface condition determined by the road-surface condition determinator, and on a basis of said degree of reliability outputted from the reliability determinator; and a target road-route determined by the automated driving module is changed on a basis of said braking distance of the host vehicle being corrected thereon.

11. The vehicle running-control processing system as set forth in claim 10, wherein the processor to execute the program and the memory to store the program sets a running road-route of a vehicle, on a basis of a road-surface condition calculated by information on an obstacle and by that on said road-surface condition, and on a basis of geographic road-map information calculated thereby.

12. The vehicle running-control processing system as set forth in claim 10, wherein the processor to execute the program and the memory to store the program specifies a maximum steering angle of a vehicle, and also performs a control to maintain a maximum steering angle of said vehicle at a predetermined value or less, on a basis of information on said road-surface condition.

13. The vehicle running-control processing system as set forth in claim 10, wherein the processor to execute the program and the memory to store the program specifies a slip rate of a tire of a vehicle, and also performs a control to maintain a slip rate of said vehicle at constant, on a basis of information on said road-surface condition.

14. The vehicle running-control processing system as set forth in claim 10, wherein the processor to execute the program and the memory to store the program specifies a running speed of a vehicle, and also performs a control to maintain a running speed of said vehicle at a predetermined value or less, on a basis of information on said road-surface condition.

15. The vehicle running-control processing system as set forth in claim 10, wherein the processor to execute the program and the memory to store the program specifies acceleration of a vehicle, and also performs a control to maintain deceleration of said vehicle at a predetermined value or less, on a basis of information on said road-surface condition.

16. The vehicle running-control processing system as set forth in claim 10, wherein
the host vehicle includes a sensor capable of detecting a state of a host vehicle's running road-surface, and
said braking distance of the host vehicle is modified on a basis of information on the road-surface obtained by the sensor.

17. The vehicle running-control processing system as set forth in claim 16, wherein
the host vehicle includes a sensor capable of detecting internal air pressure of a tire, and
said braking distance of the host vehicle is modified on a basis of internal air pressure of the tire.

18. The vehicle running-control processing system as set forth in claim 10, wherein
the host vehicle includes a storage device to store information on aging of a tire, and
said braking distance of the host vehicle is modified on a basis of the information on aging.
